(19) United States
(12) Patent Application Publication
(10) Pub. No.: US 2015/0056440 A1
(43) Pub. Date: Feb. 26, 2015

(54) MULTILAYERED SHEET

(71) Applicant: E I DU PONT DE NEMOURS AND COMPANY, Wilmington, DE (US)

(72) Inventor: Dariusz Wlodzmierz Kawka, Midlothian, VA (US)

(21) Appl. No.: 14/386,842

(22) PCT Filed: Apr. 17, 2013
(86) PCT No.: PCT/US13/36875

§ 371 Date: Sep. 22, 2014

Related U.S. Application Data
(60) Provisional application No. 61/625,950, filed on Apr. 18, 2012.

(51) Int. Cl. B32B 15/08; E04B 1/88; E04B 1/94; F16L 59/02

(52) U.S. Cl. CPC B32B 15/08; F16L 59/029; E04B 1/88; E04B 1/94; E04B 2001/742
USPC 428/337

(57) ABSTRACT

This invention pertains to a layered sheet structure comprising a carrier having a first and second surface, a metalized layer contacting one of the surfaces of the carrier and an inorganic refractory layer contacting the surface of the metalized layer not in contact with the carrier. The refractory layer has a dry area weight of from 15 to 50 gsm and a residual moisture content of no greater than 10 percent by weight. The carrier is a polymeric film, preferably polyethyleneterephthalate.

### CROSS-REFERENCE TO RELATED APPLICATIONS

This application claims the benefit under 35 U.S.C. §119(e) of U.S. Provisional Application No. 61/625,950, filed Apr. 18, 2012 which is herein incorporated by reference.

### BACKGROUND OF THE INVENTION

1. Field of Invention

This invention pertains to a multilayered sheet comprising a carrier and an inorganic refractory layer. The preferred carrier is a metalized film.

2. Background of the Invention

U.S. Pat. No. 6,322,022 to Fay at al. discloses burnthrough resistant systems for transportation especially aircraft.

U.S. Pat. No. 6,670,291 to Tomkins and Vogel-Martin describes a laminate sheet material for flame barrier applications.

U.S. Pat. No. 5,667,886 to Gough et al describes a composite sheet having a substrate layer, a coating layer and a flexible adhesive layer. The substrate layer is preferably a polyester film. The coating layer contains a mineral, preferably vermiculite.

There remains an ongoing need for methods to provide a thin inorganic refractory layer in a form that may be safely handled and subsequently processed into a multi-layer composite for use as a flame barrier component in a thermal and acoustic blanket for aircraft structures.

### SUMMARY OF INVENTION

This invention pertains to a layered sheet structure comprising a carrier having a first and second surface, a metalized layer contacting one of the surfaces of the carrier and an inorganic refractory layer contacting the surface of the metalized layer not in contact with the carrier wherein the refractory layer has a dry areal weight of from 15 to 50 gsm and a residual moisture content of no greater than 10 percent by weight, wherein the carrier

(i) is a polymeric film

(ii) has a dry tensile strength of at least 10 lb/in in a first direction and at least 5 lb/in in a second direction, the second direction being transverse to the first direction,

(iii) has a thickness of from 0.012 to 0.100 mm,

(iv) has a density of from 0.9 to 1.8 g/cc, and

(v) is thermally stable at a temperature of at least 150 degrees C. for at least 10 minutes.

### BRIEF DESCRIPTION OF DRAWINGS

FIG. 1 is a schematic cross section through a multilayered structure of this invention.

### DETAILED DESCRIPTION OF THE INVENTION

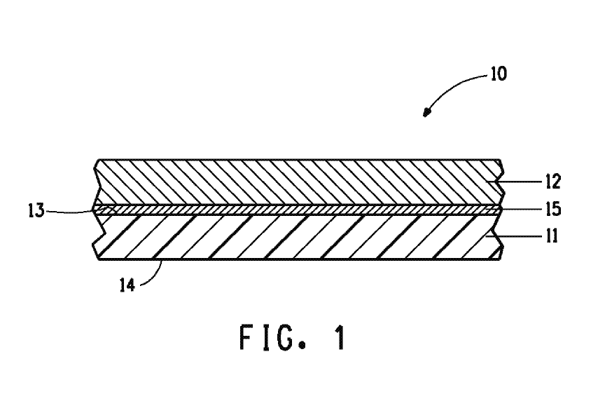

FIG. 1 shows a section through a multilayered sheet structure 10 comprising a carrier or substrate layer 11, a metalized coating layer 15 on the carrier surface and an inorganic refractory layer 12 deposited onto the surface of the metalized coating. A preferred carrier material is a high temperature polymeric film. As used herein, the terms “carrier’ and “film” are used interchangeably.

### Polymeric Carrier

The carrier is a high temperature polymeric film having a first and a second surface shown respectively at 13 and 14 in FIG. 1.

In preferred embodiments, the polymeric film has a metalized layer 15, preferably aluminum, on at least one surface of the film. The metalized surface increases the smoothness of the film surface. Increased surface smoothness of the polymeric film results in a lower release value from the film surface allowing for an easy peeling off of the inorganic refractory film-like layer either as a stand-alone unsupported web or as a laminate after thermal or adhesive bonding to a suitable support material.

The metalized surface of the film has a surface smoothness on the surface that is in contact with the refractory layer of no greater than 80 Sheffield units. Smoothness is concerned with the surface contour of film and the flatness of the surface under testing conditions which considers roughness, levelness, and compressibility. This test is an indirect measure of film smoothness or roughness. The Sheffield test method is a measurement of air flow between the test specimen (backed by flat glass on the bottom side) and two pressurized, concentric annular lands that are impressed in to the sample from top. Such a procedure is described in TAPPI T-538 om-08, In some embodiments, the carrier has a surface smoothness on at least one surface of no greater than 30 Sheffield units.

The bond strength of the metalized surface of the carrier that is in contact with the refractory layer is at least 0.005 lb/in, but no more than 0.25 lb/in. If the bond strength is less than 0.005 lb/in, the inorganic refractory layer can prematurely peel off the film with a risk of breaks in the refractory layer. A bond strength of greater than 0.25 lb/in would make it more difficult to peel off the inorganic refractory film-like layer from the film, especially as a stand-alone unsupported web. Bond strength is sometimes referred to as Release Value. In this instance, it is the Release Value between the metalized surface of the film and the intumescent coating applied to the metalized surface of the film.

The thickness of the polymeric film used in this invention is dependent upon the end use or desired properties of the laminate but, to provide a combination of overall high flexibility, dimensional stability when coated and the lowest possible weight, is typically from 0.5 to 4 mils (0.012 to 0.100 mm) or even from 1 to 3 mils (0.025 to 0.075 mm) thick. The film thickness may even be from 1.5 to 3 mil (0.037 to 0.075 mm). A film thickness below 0.5 mil would result in undesirable features such as a weaker and less dimensionally stable web, especially when coated with a heavy water based solution. A film having a thickness greater than 4 mils would add undesirable weight and stiffness.

In some embodiments, the film has a density of from 0.90 to 1.8 g/cc or from 1.30 to 1.80 g/cc or even from 1.30 to 1.50 g/cc. A film density of below 0.90 g/cc would result in undesirable features such as a weaker and excessively elastic structure.

The film has a tensile strength of at least 10 lb/in in a first direction and at least 5 lb/in in a second direction, the second direction being transverse to the first direction. In a preferred embodiment the first direction is the long direction within the plane of the film, that is, the direction in which the roll of film has been made. This is also known as the machine direction. The second direction is sometimes known as the cross direction. If the tensile strength is less than 10 lb/in in a first direction, there is a high risk of frequent film breaks during the coating process due to the weight being deposited on the film and the tension applied to the film. A tensile strength of at least 10 lb/in in a first direction is also required to ensure proper handling of the coated web through the subsequent process steps, in particular, to ensure tight roll formation during winding to prevent roll sagging and telescoping. In some embodiments, the film has a tensile strength of at least 30 lb/in in a first direction and at least 15 lb/in in a second direction, the second direction being transverse to the first direction.

The polymeric film is water stable. The dimensional stability of the polymeric film when wetted ensures that the film has the ability to hold flat for at least 2 minutes when exposed to a one-sided heavy coating.

The polymeric film layer must be capable of withstanding a temperature of at least 150 degrees C. for at least 10 minutes. These high temperature properties of the polymeric film ensures thermal and mechanical stability of the carrier during processing steps when the carrier can be exposed to a temperature of 150 degrees C. for at least 10 minutes, that is to say, that the film will not change dimensions, i.e. excessively elongate, shrink or stretch, when subjected to a temperature of 150 degrees C. for at least 10 minutes.

Preferably the polymeric film carrier layer should have a UL 94 flame classification of V-0. UL 94 flame classification is an Underwriters Laboratory test, The Standard for Flammability of Plastic Materials for Parts in Devices and Appliances, which measures a material's tendency either to extinguish or to spread the flame once the specimen has been ignited. V-0 indicates that the material is tested in a vertical position and self-extinguished within ten seconds after the ignition source is removed.

The film layer may be a thermoset or thermoplastic material, Suitable film layer materials are polyethyleneterephthalate (PET), polyketone, polyimide, polysulfone, polyarylene sulfide, fluoropolymers, liquid crystal polymers and polycarbonate. Examples of polyketone are polyetheretherketone (PEEK) and polyetherketoneketone (PEKK). Polyethersulfone and polyphenylsulfone are examples of polysulfone. Poly(p-phenylene sulfide is a suitable polyarylene sulfide for use in this invention, Polyvinylfluoride (PVF) and polyvinylidinefluoride (PVDF) are examples of fluoropolyrners. Polyarylate is an example of a suitable liquid crystal polymer. Some of these films may also be coated with a second polymeric material. For example, a polyimide film, Kapton®, may be coated with fluorinated ethylene propylene, FEP and used in this invention.

In a preferred embodiment, the film layer is a metalized fluoropolymer layer or a metalized polyester layer. Polyethyleneterephthalate is a suitable polyester material. A suitable fluoropolymer and polyethyleneterephthalate are available from E.I. du Pont de Nemours, Wilmington, DE under the tradenames Tedlar and Mylar respectively.

The surface of the metalized film layer may optionally be treated to improve adhesion. Suitable surface treatment methods include, but are not limited to, corona etching and washing with coupling agents such as ammonium, phosphonium or sulfonium salts.

In alternative embodiments, the carrier s a metallic foil or a metallic belt.

### Inorganic Refractory Layer

The inorganic refractory layer 12 is adjacent to the surface of the metalized film 15 not in contact with the carrier 11. The refractory layer has a dry areal weight of from 15 to 50 gsm and a residual moisture content of no greater than 10 percent by weight. In some embodiments, the refractory layer has a dry areal weight of from 20 to 35 gsm and a residual moisture content of no greater than 3 percent by weight.

The refractory layer comprises platelets. Preferably at least 85% of the layer comprises platelets, more preferably at least 90% and most preferably at least 95%. In some embodiments, platelets comprise 100% of the layer. The refractory layer may comprise some residual dispersant arising from incomplete drying of the platelet dispersion during manufacture.

The refractory layer has a thickness of from 7.0 to 76 micrometers and more preferably from 7.0 to 50 micrometers. Preferably, the layer has a UL 94 flame classification of V-0. The function of the refractory layer, in which adjacent platelets overlap, is to provide a flame and hot gas impermeable barrier. The inorganic platelets may be clay, such as montmorillonite, vermiculite, mica, talc and combinations thereof. Preferably, the inorganic oxide platelets are stable (i.e., do not burn, melt or decompose) at about 600 degrees C., more preferably at about 800 degrees C. and most preferably at about 1000 degrees C. Vermiculite is a preferred platelet material. Vermiculite is a hydrated magnesium aluminosilicate micaceous mineral found in nature as a multilayer crystal. Vermiculite typically comprises by (dry) weight, on a theoretical oxide basis, about 38-46% SiO₂, about 16-24% MgO, about 11-16% Al₂O₃, about 8-13% Fe₂O₃ and the remainder generally oxides of K, Ca, Ti, Mn, Cr, Na, and Ba. “Exfoliated” vermiculite refers to vermiculite that has been treated, chemically or with heat, to expand and separate the layers of the crystal, yielding high aspect ratio vermiculite platelets. Suitable vermiculite materials are available from W. R. Grace of Cambridge, Mass., under the trade designations MicroLite 963 and MicroLite HTS-XE.

The thickness of an individual platelet typically ranges from about 5 Angstroms to about 5,000 Angstroms more preferably from about 10 Angstroms to about 4,200 Angstroms. The mean value of the maximum width of a platelet typically ranges from about 10,000 Angstroms to about 30,000 Angstroms. The aspect ratio of an individual platelet typically ranges from 100 to 20,000.

Preferably, the platelets have an average diameter of from 15 to 25micrometers. In some other embodiments, the platelets have an average diameter of from 18 to 23 micrometers.

In a preferred embodiment, the refractory layer further comprises cations arising from contact, at a temperature of from 10 to 50 degrees C., with an aqueous cationic rich solution at a cation concentration of from 0.25 to 2N. The contact with the cationic solution occurs prior to assembling the refractory layer into a composite laminate. This cationic treatment provides enhanced stability to the refractory layer on exposure to fluids.

In some embodiments of this invention, the inorganic platelet layer is reinforced by a lightweight open weave fabric scrim either laid onto a single platelet layer or placed between two layers of platelets so as to provide additional mechanical strength to the layer. The scrim can be made from natural, organic or inorganic fibers with glass, cotton, nylon or polyester being typical examples. A glass fiber scrim is particularly preferred. The scrim may be a woven or knit structure and has a typical areal weight not exceeding 40 grams per square meter.

In some embodiments, the refractory layer is perforated to enhance bonding to an adhesive layer during subsequent processing. The extent of perforation is determined by experimentation. Preferably, in order to prevent compromising flame barrier properties, an individual perforation should not exceed 2 millimeters in maximum dimension. In a preferable embodiment, individual perforations should be spaced at least 10 millimeters apart. The shape of the perforations is not critical, Suitable perforations include circles, squares, rectangles, ovals and chevrons.

### Use of the Refractory Layer

The layered sheet may be used as a component in a flame barrier layer for a thermal insulation and acoustic blanket. An example of such a blanket is described in United States patent application publication 2011/0094826.

### Test Methods

The tensile strength of the film was measured according to TAPPI T494 om-06 Tensile Properties of Paper and Paperboard (Using Constant Rate of Elongation Apparatus).

The surface smoothness of the film was measured according to TAPPI T538 om-08 Roughness of Paper and Paperboard (Sheffield Method),

The thickness of the film was measured by TAPPI T411 om-10 Thickness (Caliper) of Paper, Paperboard, and Combined Board.

The density of the film is a calculated value based on the measured values of carrier thickness and basis weight.

The dimensional stability of the film was rated based on its ability to hold flat (i.e. no wrinkles or creases) for at least 2 minutes when exposed to one-sided coating.

The dry areal weight of the refractory layer was measured according to ISO 536 (1995) Determination of Grammage and TAPPI T 410 Grammage of Paper and Paperboard (Weight per Unit Area).

The moisture content of the refractory layer was measured according to ISO 287 (1985) Determination of Moisture Content—Oven Drying Method.

Selected composite sheets were subjected to a flame test that replicated the temperature and air mass flux test conditions of test method FAA FAR 25.856(b), App. F. Part VII. The somewhat lower heat flux was compensated with a higher air mass flux to replicate a required thermo-mechanical stress level to be exerted on the flame barrier composites during the burn-through test.

### EXAMPLES

In the following examples, all parts and percentages are by weight and all degrees in centigrade unless otherwise indicated. Examples prepared according to the current invention are indicated by numerical values. Control or Comparative Examples are indicated by letter

The vermiculite used was a high solids version of an aqueous dispersion of Microlite® 963 having an as supplied solids content of 7.5 percent. The dispersion was obtained from W.R. Grace and Co, Cambridge, Mass.

### Example 1

Vermiculite dispersion concentrated to a solids content of 10.6 weight percent was coated on 2-mil thick metalized polyester film using a slot die coating system to form a refractory layer on the film. The film was metalized on one side. The coating was applied to the metalized side of the film. The film was obtained under the tradename Mylar from El DuPont de Nemours and Co., Wilmington, Del. The coated film was dried in an oven at a temperature not exceeding 110 degrees C. until the inorganic refractory layer had moisture content below 5%. The total drying time exceeded 75 minutes comprising a staged drying of 15 minutes at 60 degrees, 15 minutes at 71 degrees, 15 minutes at 82 degrees, 15 minutes at 93 degrees, and over 15 minutes at 99 degrees. The refractory layer had a dry coat weight of 35 gsm. The film and refractory layers were wound up on separate rolls.

From inspecting a sample of the two layer composite sheet, it was observed that the dried refractory layer spontaneously peeled away from the metalized side of the film. The unsupported layer of the 35 gsm inorganic refractory film-like material had a tensile strength of 0.5 lbs/in.

### Example 2

This was as Example 1 except that the refractory layer had a dry coat weight of 19 gsm and the required drying time was 45 minutes. The findings were the same as for Example 1.

### Comparative Example A

Vermiculite dispersion concentrated to a solids content of 13 weight percent was coated on a 6 micron thick polyetheretherketone (PEKK) film using a slot die coating system to form a refractory layer on the film. The film was grade DS-E obtained from Cytec industries, Woodland Park, NJ. The coated film was dried in an oven at a temperature not exceeding 110 degrees C. until the inorganic refractory layer had moisture content below 5%. The drying time exceeded 45 minutes comprising a staged drying of 9 minutes at 71 degrees, 6 minutes at 82 degrees, 6 minutes at 93 degrees, and 25 minutes at 96 degrees. The refractory layer had a dry coat weight of 33 gsm. The two layer composite of film and refractory layer was wound up on a roll.

The coating process proved to be very difficult due to tendency for the film to wrinkle and crease. Further, the film had to be surface treated by a process such as corona treatment to promote wetting and give a uniform coating, Although relatively continuous refractory layer coating was obtained the refractory layer was highly non-uniform and affected by streaks and light spots related to excessive air bubbles trapped in the high viscosity solution.

### Comparative Example B

Vermiculite dispersion concentrated to a solids content of 7.5 weight percent was coated on 0.5 mil thick polyimide film using a knife over roll coating system to form a refractory layer on the film. The film was obtained under the tradename Kapton from E.I. DuPont de Nemours and Co., Wilmington, Del.. The coated film was dried in an oven at a temperature not exceeding 110 degrees C. until the inorganic refractory layer had moisture content below 5%. The drying time exceeded 75 minutes comprising a staged drying of 20 minutes at 71 degrees, 20 minutes at 82 degrees, 20 minutes at 93 degrees, and over 25 minutes at 96 degrees. The refractory layer had a target dry coat weight of 33 gsm. The two layer composite of film and refractory layer was wound up on a roll.

The coating process proved to be very difficult due to an extremely low viscosity of the coating solution combined with tendency for the film to wrinkle and crease. Further, the film had to be surface treated by a process such as corona treatment to promote wetting and give a uniform coating, A uniform and continuous refractory layer coating was not obtained.

Comparative Example C

Vermiculite dispersion concentrated to a solids content of 10.8 weight percent was coated on 2 mil thick polyimide (Kapton®) film using a slot die coating system to form a refractory layer on the film. The coated film was dried in an oven at a temperature not exceeding 110 degrees C. until the inorganic refractory layer had moisture content below 5%. The drying time exceeded 75 minutes comprising a staged drying of 9 minutes at 71 degrees, 6 minutes at 82 degrees, 6 minutes at 93 degrees, and 60 minutes at 96 degrees. The refractory layer had a dry coat weight of 33 gsm. The two layer composite of film and refractory layer was wound up on a roll.

Once dried to below 5% moisture content, a very uniform and continuous refractory layer resulted. The layer remained on the surface of the film with enough adhesion to allow for smooth roll winding and post-processing. Refractory layer was easily peeled off the polymeric film base with a help of a reinforcing substrate that was bonded to the exposed side of the refractory film. It was also possible to peel substantial sections of the refractory layer off the polymeric film base without the aid of a reinforcing substrate; however extreme care has to be taken to prevent premature breaks of the film-like refractory layer.

When exposed to a flame on the inorganic refractory layer side, the sample showed a good resistance to flame propagation, with the inorganic refractory layer acting as an effective flame barrier.

However, the drying time for a coating process in excess of 75 minutes was too long to be of practical value. Further, the inorganic refractory material showed signs of localized delamination/detachment from the polymeric film base when flexed.

### Comparative Example D

This was as Example I except that the film layer did not have a metalized surface. The findings were the same as for Comparative Example C, with the exception for flame propagation properties. When exposed to a flame on the inorganic refractory layer side, an inorganic refractory layer acted as an effective flame barrier, however the overall 2-layer composite propagated fire on the polymeric film side.

### Comparative Example E

Vermiculite dispersion was coated on 5.6 mil thick reinforced polyethylene sheet using a doctor blade. The polyethylene sheet was Tyvek® grade 1056D from DuPont. The coated sheet was dried in an oven at 90 degrees C. until the refractory layer had moisture content below 5%. The drying time was 30 minutes. The dry basis weight of of the refractory layer was 37 gsm.

The dried refractory layer could not be removed from the sheet even with the help of a reinforcing substrate bonded to the exposed side of the refractory layer. Cohesive bond failure within the refractory layer was observed. The polyethylene sheet was unsuitable for use.

### Comparative Example F

Vermiculite dispersion concentrated to a solids content of 10.8% weight percent was coated on 11 mil thick hydrophilic gray RagKraft paper using a slot die coating system to form a refractory layer on the paper. The paper comprised a blend of 50 weight percent of cellulose fibers and 50 weight percent of cotton fibers and was obtained from Crocker Technical Papers.

The paper had a basis weight of 8.1 oz/sq. yd., an average thickness of 11.0 mil, a density of 1.0 cc, a Gurley Air Resistance of 714 sec/100 cc, 20 oz. cyl., a smoothness of 103 Sheffield units, a dry tensile strength of 122.0 lb/in. in the machine direction and 40.0 lb./in. in the cross direction. The wet tensile strength was 6.4 lb/in, in the machine direction and 2.5 lb./in. in the cross direction.

The coated paper was dried for 15 minutes in an air flotation oven at a temperature not exceeding 110 degrees C. until the inorganic refractory layer had moisture content below 5%. Differential drying temperatures were applied to the top (vermiculite side) and the bottom (paper side). The drying profile on the top side was 5 minutes at 49 degrees, 5 minutes at 60 degrees and 5 minutes at 71 degrees. The drying on the bottom side was maintained for 15 minutes at 99 degrees. The refractory layer had a dry coat weight of 33 gsm. The two layer composite of film and refractory layer was wound up on a roll.

Once dried to below 5% moisture content, a very uniform and continuous refractory layer resulted. The layer remained on the surface of the film with enough adhesion to allow for smooth roll winding and post-processing. The refractory layer was easily peeled off the film base with a help of reinforcing substrate that was bonded to the exposed side of the refractory film. With extreme care it was also possible to peel short sections of the refractory layer from the paper base without the aid of a reinforcing substrate.

When exposed to a flame on the inorganic refractory layer side, the refractory layer acted as an effective flame barrier, however the overall 2-layer composite propagated fire on the paper side.

### Comparative Example G

Vermiculite dispersion concentrated to a solids content of 10.6% weight percent was coated on 5 mil thick meta-aramid paper using a slot die coating system to form a refractory layer on the paper. The paper was T413 grade Nornex® from DuPont. The paper comprised from 45 to 50 weight percent of meta-ararnid fiber and from 50 to 55 weight percent of polymeric binder in the form of fibrids.

The paper had a basis weight of 1.23 oz./sq. yd., an average thickness of 4.9 mil, a density of 0.34 g/cc, a Gurley Air Resistance of 316 sec/100 cc, 20 oz. cyl., a smoothness of 325 Sheffield units, a dry tensile strength of 10.7 lb./in. in the machine direction and 5.5 lb/in, in the cross direction. The wet tensile strength was 5.1 lb/in, in the machine direction and 2.95 lb/in, in the cross direction. The coated paper was dried for 15 minutes in an air flotation oven at a temperature not exceeding 110 degrees C. until the inorganic refractory layer had moisture content below 5%. Differential drying temperatures were applied to the top (vermiculite side) and the bottom (paper side). The drying profile on the top side was 5 minutes at 49 degrees, 5 minutes at 60 degrees and 5 minutes at 71 degrees. The drying on the bottom side was maintained for 15 minutes at 99 degrees. The refractory layer had a dry coat weight of 37 gsm. The two layer composite of paper and refractory layer was wound up on a roll.

Once dried to below 5% moisture content, a very uniform and continuous refractory layer resulted. The layer remained on the surface of the film with enough adhesion to allow for smooth roll winding and post-processing. With extreme care it was also possible to peel substantial sections of the refractory layer off the paper base with a help of reinforcing substrate that was bonded to the exposed side of the refractory film. With extreme care it was also possible to peel short sections of the refractory layer from the paper base without the aid of a reinforcing substrate.

When exposed to a flame on the inorganic refractory layer side, the refractory layer acted as an effective flame barrier, due to inherently flame resistant nature of the high strength fiber aramid carrier the overall 2-layer composite sheet did not propagate fire on the paper side.

What is claimed is:

1. A layered sheet structure comprising a carrier having a first and second surface, a metalized layer contacting one of the surfaces of the carrier and an inorganic refractory layer contacting the surface of the metalized layer not in contact with the carrier wherein the refractory layer has a dry areal weight of from 15 to 50 gsm and a residual moisture content of no greater than 10 percent by weight, wherein the carrier
(i) is a polymeric film,
(ii) has a dry tensile strength of at least 10 lb/in in a first direction and at least 5 lb/in in a second direction, the second direction being transverse to the first direction,
(iii) has a thickness of from 0.012 to 0.100 mm,
(iv) has a density of from 0.9 to 1.8 g/cc, and
(v) is thermally stable at a temperature of at least 150 degrees C. for at least 10 minutes.

2. The layered sheet of claim 1 wherein the surface value of the metalized surface of the carrier that is in contact with the refractory layer is from 0.005 to 0.25 lb/in.

3. The layered sheet of claim 1 wherein the inorganic refractory layer comprises vermiculite.

4. The layered sheet of claim 1 wherein the polymeric film is thermoplastic.

5. The layered sheet of claim 1 wherein the metalized layer is aluminum.

6. The layered sheet of claim 1 wherein the carrier is a metallic foil or a metallic belt.

7. The layered sheet of claim 1 wherein the layered structure, when wetted, has shrinkage no greater than 2 percent.

8. The layered sheet of claim 1 wherein the refractory layer has a dry areal weight of from 20 to 35 gsm.

9. The layered structure of claim 1 wherein the film has a tensile strength of at least 30 lb/in in a first direction and at least 15 lb/in in a second direction, the second direction being transverse to the first direction.

10. The layered structure of claim 1 wherein the polymeric film has a thickness of from 0.025 to 0.100 mm (1-4 mil).

11. The layered structure of claim 1 wherein the polymeric film has a thickness of from 0.038 to 0.075 mm (1.5 to 3 mil),

12. The layered structure of claim 1 wherein a smoothness on the metalized surface of the film contacting the intumescent layer is no greater than 80 Sheffield units.

13. The layered structure of claim 1 wherein a smoothness on the metalized surface of the film contacting the intumescent layer is no greater than 30 Sheffield units.

14. The layered structure of claim 2 wherein the refractory layer has a residual moisture content of no greater than 3 percent by weight.

15. The refractory layer of claim 2 wherein the layer further comprises cations.
